(19) United States
(12) Patent Application Publication
(10) Pub. No.: US 2009/0205731 A1
(43) Pub. Date: Aug. 20, 2009

(54) Hydraulic accumulator

(76) Inventor: Norbert Weber, Sulzbach (DE)

Correspondence Address: Roylance, Abrams, Berdo & Goodman, 1300 19th Street NW Suite 600, Washington, DC, 20036, US

(21) Appl. No.: 11/921,507

(22) PCT Filed: Apr. 8, 2006
(86) PCT No.: PCT/EP2006/003228

§ 371 Date: Dec. 4, 2007

(30) Foreign Application Priority Data
Jul. 30, 2005 (DE) 10 2005 035 749.0

(51) Int. Cl. F16L 55/04

(52) U.S. Cl. 138/31; 138/30

(57) ABSTRACT

The invention relates to a hydraulic accumulator, particularly in the form of a suction stream stabilizer, having an accumulator housing (10) which is provided with two fluid connections (16) between which a deflection device (22) is arranged which has an adjoining housing part (26) which accommodates a separating element which separates the interior (18) of the accumulator housing (10) from an accumulator volume (30). Solutions for long-term and functionally reliable operation can be achieved on account of the separating element being formed from a piston (28) or a bellows (50).

The invention relates to a hydraulic accumulator, especially in the form of a suction flow stabilizer, having an accumulator housing which is provided with two fluid ports, between which there is a deflection means bordered by one housing part which accommodates a separating element which separates the interior of the accumulator housing relative to the accumulator volume.

Hydraulic accumulators in the form of suction flow stabilizers are used especially when piston and diaphragm pumps are used in fluid circuits, for example in supply systems, in reactors and in the chemical industry. Trouble-free pump operation is fundamentally only possible when no cavitation occurs within the pump and pipeline vibrations are avoided. The relatively large liquid volume in the accumulator housing of the suction flow stabilizer, viewed with reference to the displacement volume of the pump used in the fluid circuit, reduces the acceleration effects of the liquid column in the assigned suction line which is connected to one of the fluid ports of the accumulator housing of the hydraulic accumulator. Gas separation is also achieved by the extremely low flow velocity in the accumulator housing of the suction flow stabilizer and by deflection of the fluid flow on the deflection means usually in the form of a baffle plate. This in turn benefits trouble-free pump operation. By matching the filling overpressure, actively on the separating element, optimum pulsation damping is achieved relative to the operating conditions of the fluid circuit.

In the known hydraulic accumulator solutions as a suction flow stabilizer, the separating element is generally a bladder which is conventionally formed from an elastomer material. This material of the bladder is susceptible to corrosive media and if the fluid flow to be transported by the hydraulic accumulator is fouled, this can lead to mechanical damage on the bladder, thus possibly entailing the complete failure of the hydraulic system. Since nitrogen gas is generally used in the bladder to produce the filling overpressure, it can diffuse through the diaphragm material to the liquid side so that with increasing length of use of the suction flow stabilizer, loss of gas occurs; this reduces the effectiveness of the stabilizer and consequently its length of use. If temperature fluctuations occur in operation of the known solution, this can lead in turn to major pressure changes on the pre-charge pressure side within the bladder with the result that the operation of the suction flow stabilizer is adversely affected.

On the basis of this prior art, the object of the invention is to further improve the known solutions such that they can be reliably used over the long term. This object is achieved by a hydraulic accumulator with the features of claim 1 in its entirety.

In that, as specified in the characterizing part of claim 1, the separating element is formed from a piston or bellows, preferably for the separating element metal materials can be used which are less susceptible to corrosive media than the material of the known bladder. The solution according to the invention is also less susceptible to dirt in the fluid flow crossing the stabilizer; this applies especially when a metal bellows solution is used. Since the respective separating element in the form of a piston and/or a bellows can also withstand the intended pre-charge pressure over the long term, reliable operation is ensured in this respect over the long term and is also promoted by the fact that the solution according to the invention is less susceptible on the pre-charge pressure side. In particular, using a bellows, preferably composed of metal material, ensures that on the pre-charge pressure side losses of media and gas cannot occur. Using the piston accumulator solution can also result in smaller gas losses than in the known bladder-type accumulator solutions. With the solution according to the invention, for this purpose largely hermetic sealing of the accumulator medium on the separating element side of the device is achieved.

Another advantage when using the piston accumulator solution according to the invention results in that a larger pressure ratio (pre-charge pressure to operating pressure) than for bladder-type accumulator and metal bellows accumulator solutions is allowable. Thus less impact by temperature fluctuations can be achieved.

Other advantageous embodiments of the hydraulic accumulator according to the invention are the subject matter of the other dependent claims.

The hydraulic accumulator solution according to the invention will be detailed below using two embodiments as shown in the drawings. The figures are schematic and not to scale.

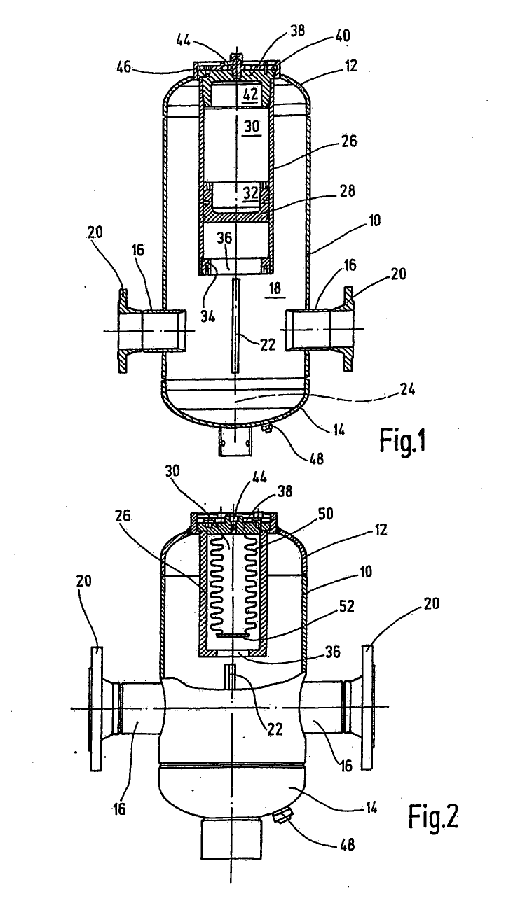

FIG. 1 shows a longitudinal section through the hydraulic accumulator with the piston solution implemented;

FIG. 2 shows a hydraulic accumulator solution with a bellows used partially in a longitudinal section, partially in a front view.

The hydraulic accumulator shown in FIG. 1 is made in the manner of a suction flow stabilizer. In particular, these suction flow stabilizers are used on the intake side of piston pumps (not shown). In practice it has proven favorable to provide installation of the hydraulic accumulator as near as possible to the suction connection of the pump with a vertical installation position. The suction flow stabilizer has an accumulator housing 10 with two cover parts 12, 14 which can be connected via welds, which are not shown, to the actual cylindrical accumulator housing 10. In the direction of the lower cover part 14, the accumulator housing 10 is penetrated by two fluid ports 16 which project with a definable projection into the interior 18 of the accumulator housing 10 and are also located at the same vertical position to one another. Two attachment flanges 20 are located to the outside on the fluid ports 16 by way of a weld which in turn is not shown; the flanges are used for the purpose of connecting the suction flow stabilizer to the fluid circuit, which is not detailed, with a feed pump.

Approximately in the middle between the entry points of the two fluid ports 16, there is a deflection means 22 which is made in the manner of a deflection plate which with its two face sides is attached stationary within the accumulator housing 10. This deflection means 22 is used to deflect the fluid flow entering the accumulator housing 10 between the two fluid ports 16 essentially at a right angle. Located above the deflection means 22 and approximately in the middle to the longitudinal axis 24 of the accumulator housing 10, while maintaining a definable distance the deflection means 22 borders the cylindrical housing part 26 with a piston 28 which is guided to be longitudinally displaceable on its inside. For the sake of simplicity, the seals and guide belts for the piston 28 have been omitted and for this purpose only its receivers on the outer periphery are shown. The piston 28 with the housing part 26 borders an accumulator volume 30 which is filled with a working medium, preferably in the form of nitrogen gas, of a definable pressure. In order to increase the accumulator volume 30, the piston 28 is provided with a cylindrical depression 32 which can be assigned to the accumulator volume 30 in terms of its volume. Instead of nitrogen as the working medium, a mechanical helical spring can also be used for energy storage.

The housing part 26, viewed in the direction of looking at FIG. 1, is provided toward the bottom in the direction to the deflection means 22 with a screw-on sealing bottom 34 which borders the fluid passage opening 36 which discharges into the interior 18 of the accumulator housing 10. The partition of the deflection means 22 follows bordering directly underneath and lying in the longitudinal axis 24 of the vessel. To the top, an end cap 38 is screwed into the cylindrical housing part 26, said end cap widening preferably in steps to the outside, discharging into a receiving collar 40 which in turn along its bottom side by way of a weld, which is not shown, is connected to the upper cover part 12 of the accumulator housing 10.

In one embodiment, which will not be detailed, a cover with a straight structure can also be used. In addition, the end cap 38 has a recess 42 which is comparable in terms of its outside dimensions to the depression 32 in the piston 28. Like the depression 32, the recess 42 is used to increase the accumulator volume 30 of the housing part 26. The end cap 38 is provided with a refilling means 44 in the form of a refill valve. This refilling means 44 is used to connect a refill bottle for filling the accumulator volume 30 with the working medium, especially in the form of a working gas. In addition the top end of the end cap 38 can be supported on the collar 40 by way of a retaining ring 46 and on the lower cover part 14 there is a drain plug 48 by means of which the interior 18 of the accumulator housing 10 can be emptied of fluid, for example for maintenance purposes.

The advantage of the piston solution consists in particular in that the piston 28, depending on the temperature, can “work” directly in different positions within the housing part 26. In this way there are then no limited pressure fluctuation regions. Limitation of the maximum working capacity is ensured by the option of the piston 28 striking the sealing bottom 34. Since the piston 28 can be sealed very effectively relative to the housing part 26, gas losses from the accumulator volume side 30 in the direction of the interior 18 of the fluid which is stored within the accumulator housing 10 are largely precluded so that insofar reliable, long-lasting operation is ensured.

The following embodiment as shown in FIG. 2 will be explained only to the extent that it differs substantially from the embodiment shown in FIG. 1, the same components as in the first embodiment being provided with the same reference symbols and, in this context, previous details also applying to the other embodiment as shown in FIG. 2.

In the embodiment as shown in FIG. 2, the separating element is a bellows 50, especially in the form of a metal bellows which with its plurality of folds, while maintaining a radial distance, extends along the inside of the cylindrical housing part 26. The metal bellows 50, viewed in the direction of looking at FIG. 2, on its upper end is fastened on the end cap 38 and the free lower end terminates on a sealing plate 52 with an outside diameter which is greater than the free diameter of the fluid passage opening 36. For this purpose, for expanding the bellows 50, then, in turn, a limitation based on the sealing plate's 52 possibly striking the lower housing part wall, which borders the fluid passage opening 36 on the edge side, is implemented.

The housing part 26 is in turn made cylindrical and ends with the fluid passage opening 36 shortly above the wall of the deflection means 22 which is shown in this respect only with its top end. The bellows 50 can in turn enclose gas-tight the accumulator volume 30 which can be supplied with a working medium, such as a working gas, via the refilling means 44 in the end cap 38. But in addition to the working gas, media such as fluids, for example in the form of ethyl alcohol, can also be used to stiffen the bellows 50. With the bellows solution a quasi-tight situation is achieved and losses of gas in effect hardly occur. Furthermore the bellows 50 is very favorable in its working behavior relative to suction flow stabilization and is resistant to all media to be stabilized which occur in practical application. Another advantage of the solution according to the invention is that the pre-charge pressure, limited by the separating element, need not be limited to the maximum operating pressure of the accumulator solution and, in this way, within a widely drawn framework, there are adjustment possibilities, considering that the conventional bladder-type accumulator solutions allow only pressure ratios of 4:1.

1. A hydraulic accumulator, especially in the form of a suction flow stabilizer, having an accumulator housing (10) which is provided with two fluid ports (16), between which there is a deflection means (22) bordered by one housing part (26) which holds a separating element which separates the interior (18) of the accumulator housing (10) relative to the accumulator volume (30), characterized in that the separating element is formed from a piston (28) or bellows (50).

2. The hydraulic accumulator according to claim 1, wherein the housing part (26) on its free end has a fluid passage opening (36) and is attached with its other end to the accumulator housing (10).

3. The hydraulic accumulator according to claim 2, wherein the housing part (26) on its end facing the accumulator housing (10) is provided with a refilling means (44).

4. The hydraulic accumulator according to claim 1, wherein the deflection means (22) consists of a partition which in each instance is placed with the same distance between the fluid ports (16).

5. The hydraulic accumulator according to claim 2, wherein the fluid passage opening (36) in the housing part (26) can be sealed by means of the separating element.

6. The hydraulic accumulator according to claim 1, wherein an accumulator medium, especially in the form of nitrogen gas and/or in the form of a helical mechanical spring, is present in the housing (26), bordered by the separating element.

7. The hydraulic accumulator according to claim 1, wherein the piston (28) is guided along its outer periphery in the housing part (26).

8. The hydraulic accumulator according to claim 1, wherein the bellows (50) made as a folding bellows extends with a definable radial distance along the housing part (26).
